(19) United States
(12) Patent Application Publication
(10) Pub. No.: US 2025/0314521 A1
(43) Pub. Date: Oct. 9, 2025

(54) SYSTEM AND METHOD FOR CALIBRATING A FORMULA DISPENSER AND A FORMULA DISPENSER

(71) Applicant: Dr. Brown's Company, St. Louis, MO (US)

(72) Inventors: Douglas Hanneken, St. Louis, MO (US); Bernard J. Kemper, Bonne Terre, MO (US)

(21) Appl. No.: 19/042,259

(22) Filed: Jan. 31, 2025

Related U.S. Application Data
(60) Provisional application No. 63/575,923, filed on Apr. 8, 2024.

(51) Int. Cl. G01F 25/00; A23L 33/00; A47J 31/40

(52) U.S. Cl. CPC G01F 25/0092; A23L 33/40; A47J 31/404

(57) ABSTRACT

Systems and methods for calibrating a formula dispenser include depositing a manufacturer-prescribed amount of powder into a cavity of a marked container including level markings that correspond to formula calibration numbers. A level of the deposited powder in the cavity of the marked container is compared to the level markings on the marked container, and a formula calibration number is determined. A controller of the formula dispenser is configured to receive the formula calibration number and determine a formula recipe based on the formula calibration number. Powder is dispensed from a discharge outlet of the formula dispenser into the cavity of the marked container according to the formula recipe. A level of the dispensed powder in the marked container is compared to the level markings on the marked container to determine if the level of the dispensed powder corresponds to the formula calibration number inputted into the formula dispenser.

### CROSS-REFERENCE TO RELATED APPLICATION

This application claims priority to U.S. Provisional Application No. 63/575,923 filed on Apr. 8, 2024, the entire content and disclosures of which are incorporated herein by reference in their entireties.

### BACKGROUND

The field of this disclosure relates generally to dispensers and more particularly to a system and method of calibrating dispensers for powder or powder-based mixtures such as formula.

Dispensers are useful for preparing infant formula, drinks, food, or other powder-based mixtures. Dispensers typically include a metering assembly that dispenses a measured quantity of powder from a reservoir. During or after dispensing, the dispensed powder may be mixed with a suitable liquid such as water. Accordingly, the dispensers are useful for preparing mixtures requiring a predetermined volume of powder.

Powder-based mixtures have different ratios of powder and liquid and, thus, the dispensers must be precisely set to provide the correct amount of powder for each powder-based mixture. For example, manufacturers of powder-based mixtures typically provide a scoop that is sized to contain a manufacturer prescribed amount of powder for a powder-based mixture. To prepare the powder-based mixture according to the manufacturer recipe, the dispenser must dispense an amount of powder that matches the manufacturer prescribed amount. For example, the dispenser may dispense a lesser or greater amount of powder for infant formula than is prescribed by the formula recipe, resulting in an infant being under-or over-nourished. At least some dispensers allow users to enter settings that correspond to or approximate manufacturer recipes. However, the settings may not account for differences in an operating state or performance of the dispenser. In addition, the settings are difficult to generate and keep continuously updated based on the manufacture's recipes. Moreover, the settings may be difficult for a user to understand and input correctly. In addition, at least some systems require a user to weigh powder using a scale which further complicates the process and requires the user to have an available scale.

Therefore, there is a need for a reliable and simple system for calibrating a dispenser for powder-based mixtures.

### SUMMARY

In one aspect, a method for calibrating a formula dispenser using a formula calibration system is provided. The formula calibration system includes a marked container. The method includes depositing a manufacturer-prescribed amount of powder into a cavity of the marked container. The marked container includes level markings that correspond to formula calibration numbers of the formula dispenser. The method also includes comparing a level of the deposited powder in the cavity of the marked container and the level markings on the marked container, and determining a formula calibration number based on the comparison of the level of the deposited powder and the level markings on the marked container. The method further includes inputting the formula calibration number using a user interface connected to the formula dispenser. A controller of the formula dispenser is configured to receive the formula calibration number and determine a formula recipe based on the formula calibration number. The method also includes positioning the marked container to receive powder dispensed from a discharge outlet of the formula dispenser, dispensing powder according to the formula recipe from the discharge outlet of the formula dispenser into the cavity of the marked container, comparing a level of the dispensed powder in the marked container and the level markings on the marked container, and determining if the level of the dispensed powder in the marked container corresponds to the formula calibration number inputted into the user interface.

In another aspect, a system for calibrating a formula dispenser includes a formula dispenser having a discharge outlet, and a marked container arranged to receive powder dispensed from the discharge outlet of the formula dispenser. The marked container includes a sidewall defining a cavity sized to receive the powder dispensed from the discharge outlet of the formula dispenser, and level markings that correspond to formula calibration numbers for the formula dispenser. The system also includes a controller configured to receive an input of a formula calibration number, determine a formula recipe based on the formula calibration number, and cause the formula dispenser to dispense powder into the marked container according to the formula recipe. The formula calibration number is based on a comparison of a level of the powder in the marked container and the level markings on the sidewall. The controller is configured to receive a confirmation that a level of the dispensed powder in the marked container corresponds to the formula calibration number inputted into the formula dispenser based on a comparison of the level of the dispensed powder in the marked container and the level markings.

In yet another aspect, a dispenser includes a discharge outlet arranged to dispense powder, and a container interface arranged to receive a marked container in a position to receive powder dispensed from the discharge outlet. The marked container includes a sidewall defining a cavity sized to receive the powder dispensed from the discharge outlet, and level markings. The level markings correspond to calibration numbers for the dispenser. The marked container is arranged such that a user can compare a level of the powder in the marked container to the level markings. The dispenser includes a controller configured to receive an input of a calibration number, cause the dispenser to dispense powder into the cavity of the marked container based on the calibration number, and receive a confirmation that the level of the dispensed powder in the cavity of the marked container corresponds to the calibration number inputted into the dispenser based on a comparison of a level of the dispensed powder in the marked container and the level markings.

### BRIEF DESCRIPTION OF THE DRAWINGS

FIG. 1 is a perspective view of one suitable embodiment of a dispenser.

FIG. 2 is a front view of the dispenser.

FIG. 3 is a simplified schematic diagram of a portion of the dispenser and a calibration system for use with the dispenser, the calibration system including a marked container.

FIG. 4 is a perspective view of the marked container connected to the dispenser.

FIG. 5 is a front view of the marked container connected to the dispenser.

FIG. 6 is a perspective view of the marked container.

FIG. 7 is a top view of the marked container.

FIG. 8 is a side view of the marked container.

FIG. 9 is a front view of the marked container.

FIG. 10 is a flow diagram of one suitable embodiment of a method for calibrating the dispenser using the calibration system.

FIGS. 11-16 are simplified schematic diagrams illustrating steps of calibrating the dispenser using the calibration system.

### DETAILED DESCRIPTION OF THE DRAWINGS

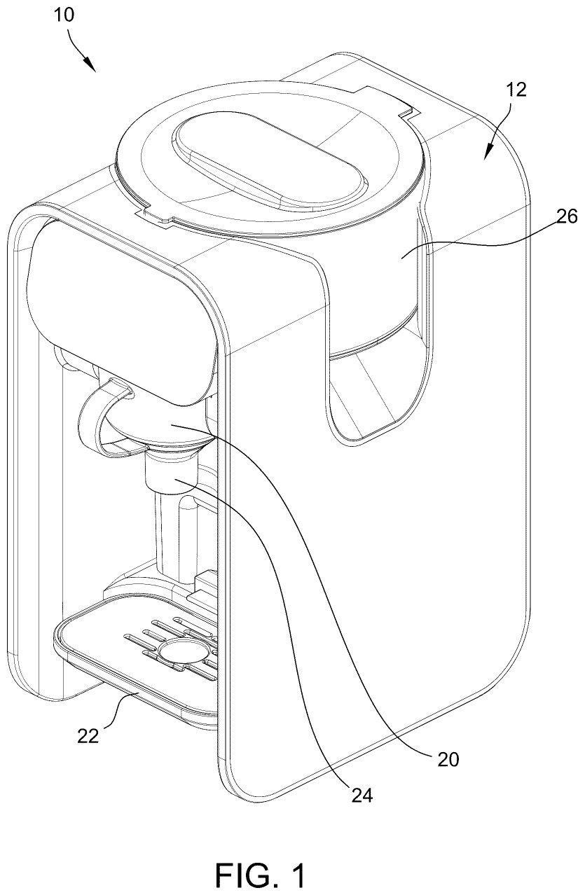

With reference now to the accompanying drawings, and specifically to FIGS. 1-3, a dispenser according to one suitable embodiment of the present disclosure is illustrated and is indicated generally at 10. The dispenser 10 may be used to dispense, for example and without limitation, powder, fluid, and/or powder and fluid. For example, the dispenser 10 may be used to prepare powder-based mixtures such as infant formula, beverages, and/or food. The dispenser 10 illustrated in FIGS. 1-3 is configured to dispense powdered infant formula. As used herein, the term “powder” refers to a material comprised of a plurality of solid particles.

The dispenser 10 is configured to dispense precise volumes of powder and is able to vary the volume of dispensed powder according to different recipes for powder-based mixtures. For example, the dispenser 10 is configured to dispense powder 16 into a container such as a bottle. The powder 16 may be mixed with a liquid such as water to form a mixture. For example, the dispenser 10 includes a funnel 20 that receives the powder and the liquid and acts as a mixing compartment. The liquid may be dispensed into the funnel 20 from a liquid outlet 18 connected to a liquid supply (not shown). In another suitable embodiment, the powder may be dispensed by the dispenser 10 through the funnel 20 and into the container in a “dry” state, i.e., without liquid. The funnel 20 includes an outlet 24 for the powder or mixture to exit the funnel and be dispensed into the container.

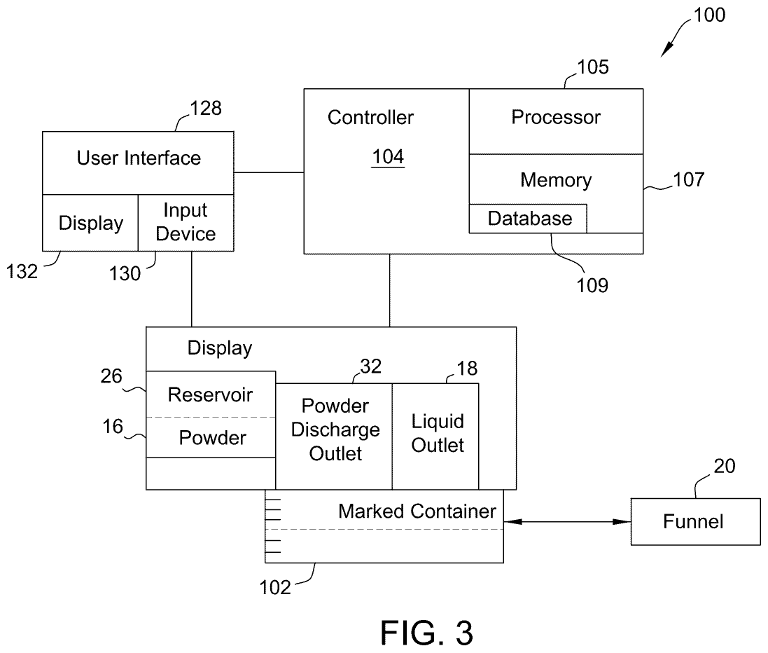

As seen in FIG. 1, the dispenser 10 includes a suitable housing, indicated generally at 12, for housing various working components of the dispenser such as a motor assembly (not shown). In suitable embodiments, the dispenser 10 includes a user interface 128 (FIG. 3) configured to display messages and receive inputs from a user. For example, the user interface 128 may be used to receive user inputs relating to amounts of powder to be dispensed or instructions relating to a mixture recipe. For example, the user interface 128 includes an input device 130 and a display 132, as shown in FIG. 3. The user interface may be incorporated with the housing 12 and/or may be located at least in part on a remote device such as a computing device (e.g., a laptop, a tablet, a smartphone).

In addition, the dispenser 10 includes a reservoir 26 mounted on the housing 12 and adapted to contain a powder, and a stand 22 configured to support the container while the dispenser 10 dispenses the powder or a mixture through the outlet 24 of the funnel 20 and into the container. The reservoir 26 may have any suitable size and shape. Suitably, the reservoir 26 is a cylinder and has a diameter and a height. In suitable embodiments, the diameter of the reservoir 26 is greater than the height of the reservoir. The arrangement of the reservoir 26 facilitates the dispenser 10 receiving and dispensing the powder.

During operation, the dispenser 10 dispenses the powder 16 from the reservoir 26 through a discharge outlet 32 and into the funnel 20 where the powder may be mixed with a liquid. The powder or a mixture is dispensed through the outlet 24 of the funnel 20 into the container. The reservoir 26 is disposed above the funnel 20 and the stand 22 such that powder can flow from the reservoir 26, through the funnel 20, and into the container positioned on the stand 22 at least partly due to the force of gravity.

The funnel 20 is removably attached to the housing 12. For example, the housing 12 includes a container interface 28 that receives engagement features on the funnel 20. For example, the funnel 20 includes at least one flange 31 that extends radially outward from a rim of the funnel 20 and is received in slots 30 defined by the container interface 28. The funnel 20 is arranged to receive the powder dispensed from the powder discharge outlet 32 (FIG. 3) and the liquid dispensed from a liquid outlet 18 (FIG. 3) when the funnel 20 is attached to the housing 12. In other examples, the funnel 20 may be permanently attached and/or incorporated into the housing 12. In further examples, the funnel 20 is omitted and the powder and/or the liquid is discharged directly into a container.

During operation, the reservoir 26 is filled or partially filled with a powder. The dispenser 10 operates to mix and distribute the powder 16 within the reservoir 26. For example, a motor (not shown) is configured to induce rotation of a rotor via a drive shaft and blades on the rotor contact the powder as the rotor rotates within the reservoir to prevent clumping of the powder 16 and facilitate the powder 16 having a proper consistency and fluidity. A predetermined volume of powder 16 is dispensed through the powder discharge outlet 32 and into the funnel 20 where the powder 16 may be mixed with a liquid. The volume of powder 16 dispensed by the dispenser 10 can be selectively varied to provide different volumes of powder 16 and prepare a broad range of mixtures. Suitably, the dispenser 10 dispenses the volume of powder 16 based on user inputs and/or a preset recipe. For example, the dispenser 10 provides a volume of liquid that corresponds to a volume of powder 16 selected by a user via the user interface 128. The powder 16 or a mixture is dispensed through the outlet 24 of the funnel 20 into the container.

FIG. 3 is a simplified schematic diagram of a portion of the dispenser 10 and a calibration system, indicated generally at 100, for use with the dispenser. The calibration system 100 includes a marked container 102 and a controller 104. The controller 104 has a processor 105 and a memory 107. The controller 104 may be incorporated into the dispenser 10 and/or located on a remote computing device. In the example, the controller 104 is at least partly located on board the dispenser 10 and is configured to control operation of the dispenser 10. For example, the controller 104 is configured to regulate operation of the dispenser 10 to meter the amount of powder and/or liquid that is discharged into a container.

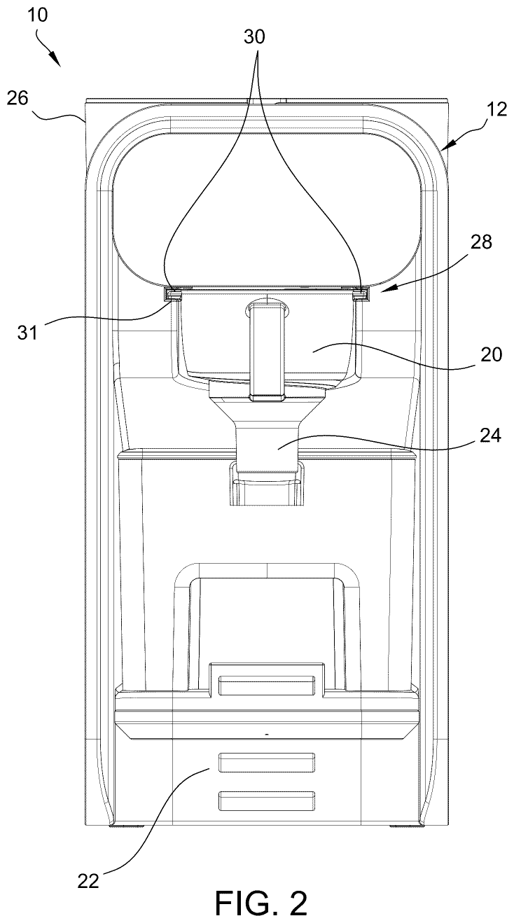

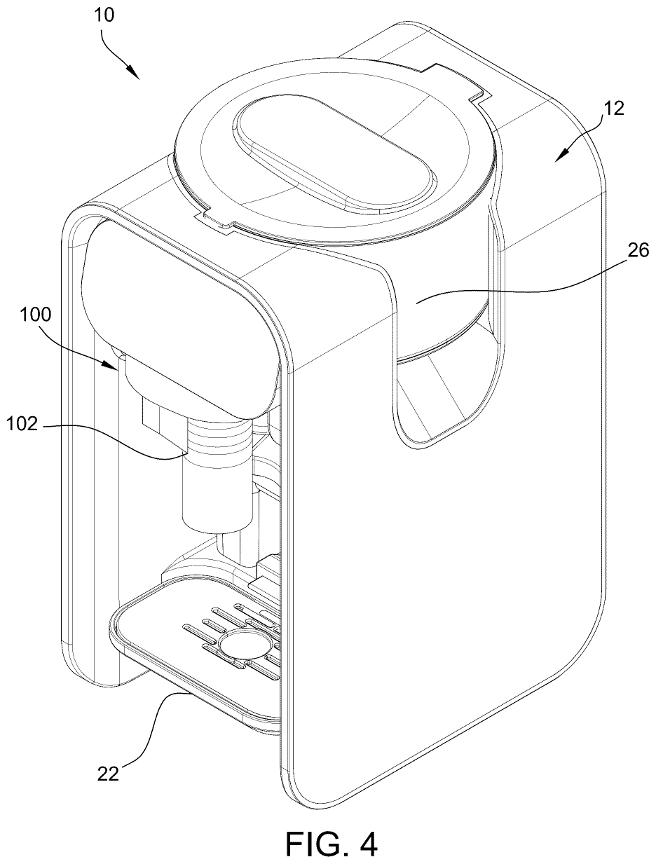

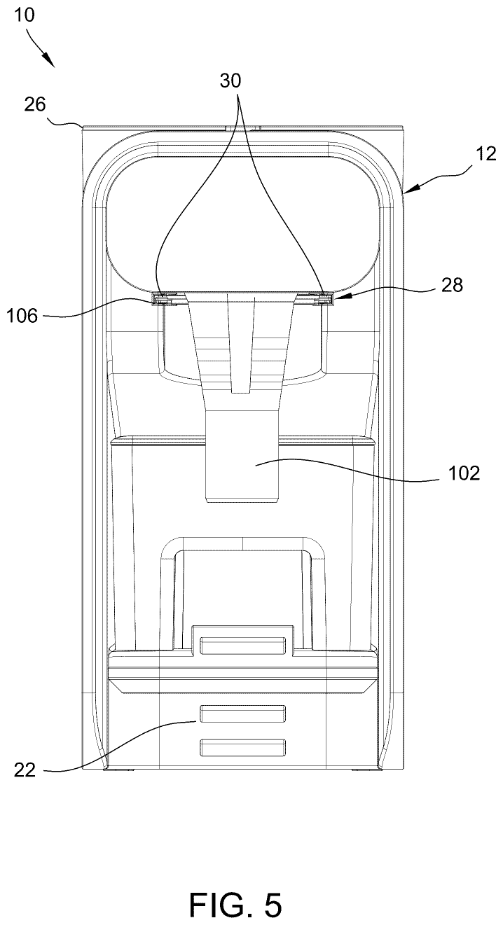

As seen in FIGS. 4 and 5, the marked container 102 is arranged to interface with the dispenser 10 and receive powder dispensed from the discharge outlet 32 of the dispenser. For example, the marked container 102 includes flanges 106 that are arranged to engage the slots 30 defined by the container interface 28 of the housing 12. The marked container 102 is released from or connected to the housing 12 by moving the flanges 106 out of or into the container interface 28. In other embodiments, the marked container 102 and the dispenser 10 are connected in any suitable manner. For example, in some examples, the marked container 102 is positioned on and supported by the stand 22 (shown in FIGS. 1 and 2).

Referring to FIGS. 3-5, in the example, the marked container 102 is interfaced with the dispenser 10 in place of the funnel 20. Accordingly, the liquid and/or powder is dispensed into the marked container 102 without passing through the funnel 20. As a result, the calibration system 100 facilitates a precise amount of powder being discharged directly into the marked container 102 without losses due to interceding components and/or mixing with liquids. In other examples, the marked container 102 and the funnel 20 may be incorporated into a single component and/or otherwise be usable at the same time. For example, the marked container 102 may be positionable to receive and measure a powder mixture dispensed from the funnel 20. In further examples, the funnel 20 and the marked container 102 may be incorporated into a single component that has two or more configurations (e.g., a mixing configuration and a measuring configuration) and switches between the configurations to selectively provide mixing, dispensing, and/or measuring functions.

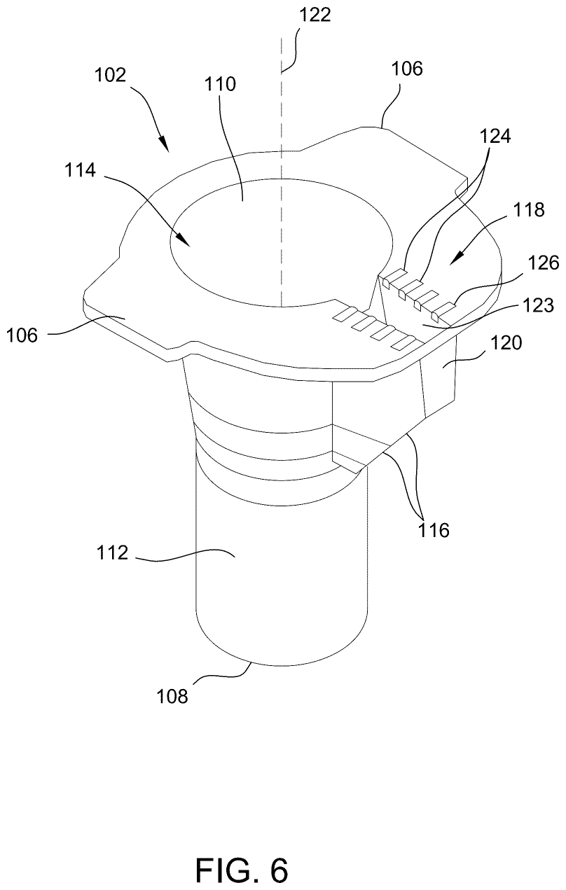

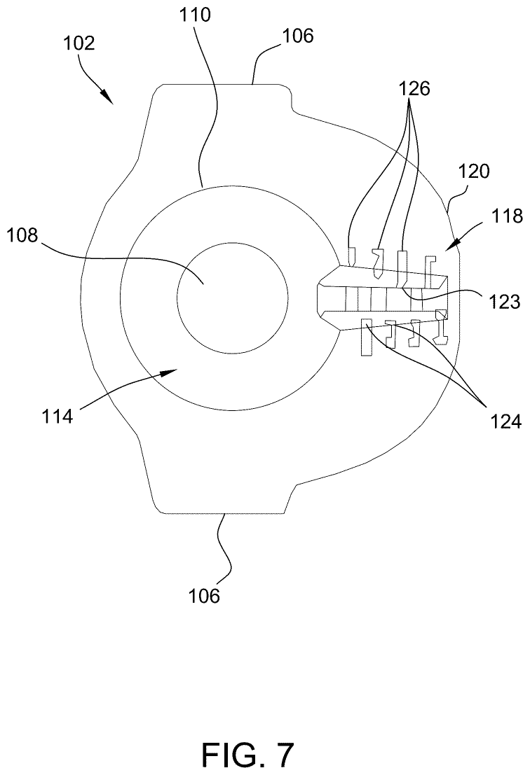

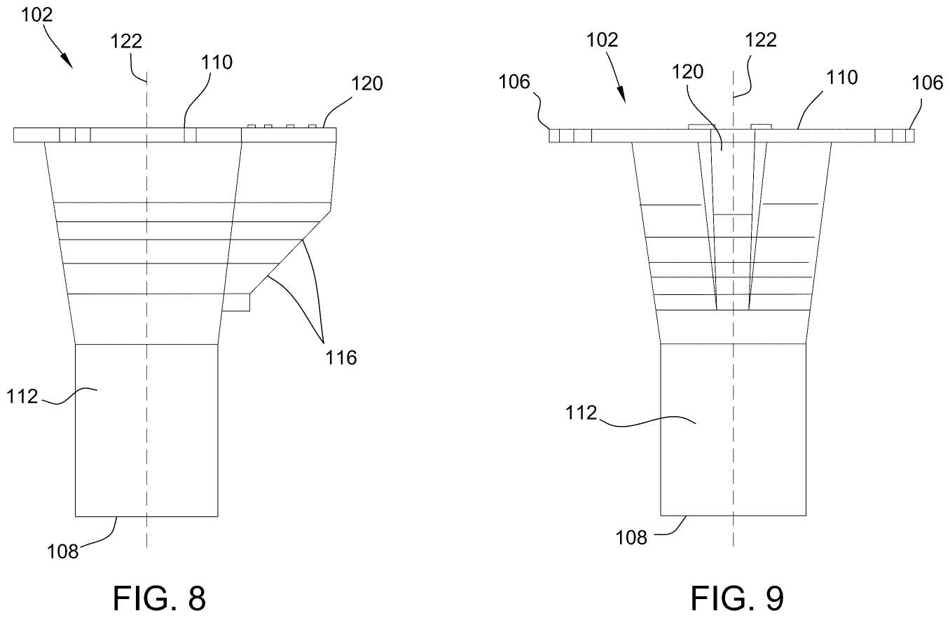

As seen in FIGS. 6-9, the marked container 102 includes a bottom 108, an open top 110 opposite the bottom, and a sidewall 112 extending between the bottom and the open top. The sidewall 112 and the bottom 108 define a cavity 114 sized to receive the powder dispensed from the discharge outlet 32 of the dispenser 10 (FIG. 3). In the example, the dispensed powder is deposited into the cavity 114 through the open top 110 of the marked container 102.

The marked container 102 is a cylinder. For example, the sidewall 112 extends around and along an axis 122. In addition, the marked container 102 is at least partly tapered between the open top 110 and the bottom 108, e.g., the marked container 102 has a diameter at the open top 110 that is larger than its diameter at the bottom 108. For example, the sidewall 112 of the marked container 102 defines a tapered section that extends at an angle relative to the axis 122 of the marked container. The angle may be in a range of 5° to 10°. In the example, the tapered section of the sidewall 112 extends between the open top 110 and the bottom 108 at an angle of 8° relative to the axis 122. The taper of the marked container 102 facilitates the user reading the level of the material within the cavity 114 and leveling of the material. Also, the taper of the marked container 102 may make it easier to remove material from the cavity 114 of the marked container 102.

As seen in FIGS. 5-9, at least one flange 106 extends outward from the sidewall 112 adjacent the open top 110. For example, the marked container 102 includes a pair of diametrically opposite flanges 106 extending radially outward from the sidewall 112. The flanges 106 are arranged to engage the container interface 28 of the housing 12. For example, the flanges 106 are sized and shaped to fit into the slots 30 of the container interface 28 (shown in FIG. 5). In a suitable embodiment, the flanges 106 are planar and smooth (e.g., free of surface features) to facilitate the flanges 106 sliding into and out of the slots 30 of the container interface 28.

In addition, in the example, the marked container 102 includes level markings 118. The level markings 118 correspond to calibration numbers (e.g., formula calibration numbers) for the dispenser 10. For example, the calibration numbers are assigned by the manufacturers of the powder and relate to categories of recipes for powder-liquid mixtures that may be produced using the powder. Each recipe may designate a manufacture-prescribed amount of powder and a manufacture-prescribed amount of liquid required for a specified volume of the powder-based mixture. The dispenser 10 uses the calibration numbers to determine settings that cause the manufacture-prescribed amount of powder and/or liquid to be dispensed based on a selected recipe for the powder-based mixtures. For example, each calibration number may correspond to a predetermined amount of powder to be dispensed by the dispenser 10.

As seen in FIGS. 5-9, the level markings 118 include graduation lines 124 that correspond to a specified volume of material (e.g., powder, liquid, or powder and liquid) contained within the cavity 114, and indicators 126 that relate each graduation line to a calibration number. For example, the indicators 126 may include printed calibration numbers that are located next the respective graduation line 124. In some examples, the graduation lines 124 are not numbered and instead the indicators 126 include a label or directions that instruct a user how to translate the graduation lines to the calibration numbers (e.g., instructions to count the number of lines in a designated direction). The number of graduation lines 124 provided on the marked container 102 determines the resolution with which the level of the material within the marked container can be measured. In the example, the marked container 102 includes eight of the graduation lines 124. The graduation lines 124 are spaced apart to provide easy identification by a user with the required accuracy for calibration of the dispenser 10 (shown in FIG. 1). In other examples, the marked container 102 may include more or less of the graduation lines 124. In the example, the marked container 102 has steps 116 (e.g., changes in diameter of the marked container) that correspond with the graduation lines 124 and facilitate the powder having a predetermined volume at each graduation line. In other suitable embodiments, the marked container is a straight graduated cylinder.

In the embodiment illustrated in FIGS. 5-9, the marked container 102 includes a view ledge 120 that extends outward from the sidewall 112 of the marked container 102. For example, the view ledge 120 extends from the tapered section of the sidewall 112. The view ledge 120 includes an angled groove 123 that is connected with the cavity 114 of the marked container 102 such that powder that is deposited into the marked container 102 flows into the angled groove when the powder is above a predetermined level. In addition, in the example, the level markings 118 are located on the view ledge. The view ledge 120 facilatates a user quickly and easily identifying the level of the powder within the marked container 102. The view ledge 120 may be omitted in some embodiments without departing from aspects of the disclosure.

Suitably, the marked container 102 is constructed of a transparent material to facilitate a user determining the level of the material within the cavity 114 from an exterior of the marked container. In one suitable embodiment, for example, the marked container 102 is constructed of a clear plastic material. In other suitable embodiments, the marked container 102 may be constructed of glass, plastic, and/or any other suitable material. For example, in some suitable embodiments, the marked container 102 may be constructed of an “anti-static” material or a coating may be added to the marked container with a low coefficient of friction or static to improve the ability to settle the powder within the marked container for identifying the powder level.

Referring again to FIG. 3, during operation, a user compares a level of the powder in the marked container 102 to the level markings 118 and determines calibration information (e.g., the calibration number) based on the comparison. The controller 104 is configured to receive the calibration information and regulate powder and/or liquid that is dispensed by the dispenser 10 based on the calibration information. For example, the controller 104 is configured to receive a formula calibration number that is determined based on the comparison of the level of the powder in the marked container to the level markings 118 on the marked container 102.

The user may input the formula calibration number into the calibration system 100 using the user interface 128. For example, the display 132 of the user interface 128 may display formula calibration numbers stored in the memory 107 of the controller 104, and the user may select the determined formula calibration number from the list or type the formula calibration number via the input device 130. The controller 104 is connected to the user interface 128 and configured to receive the information input by the user via the user interface 128.

In addition, the controller 104 is configured to determine a recipe based on the calibration number. For example, the controller 104 is configured to, based on the user inputs, select a calibration number from a database of calibration numbers stored on the memory 107 and retrieve from the memory the recipe and operating parameters of the dispenser 10 that relate to the calibration number. The recipe may include a manufacturer-recommend amount of the powder and/or the liquid. The controller 104 is configured to cause the dispenser 10 to dispense powder according to the recipe.

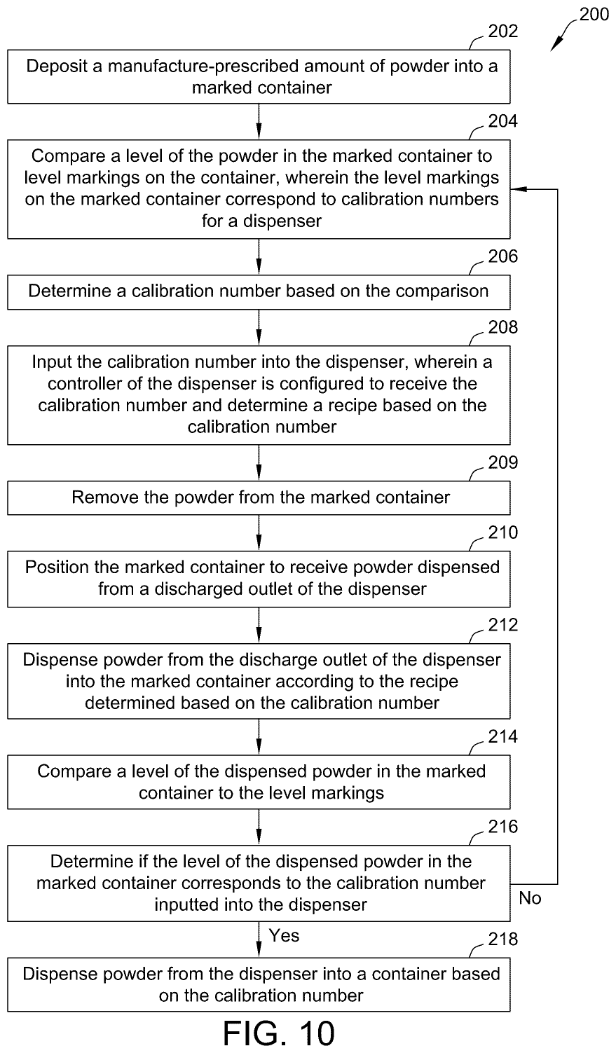

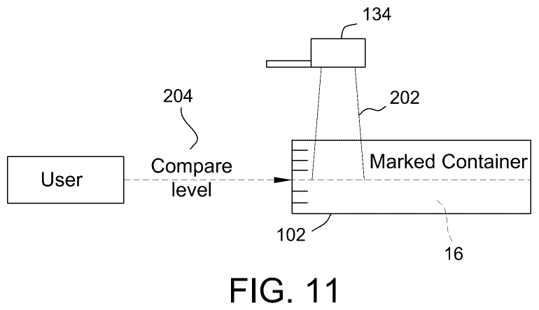

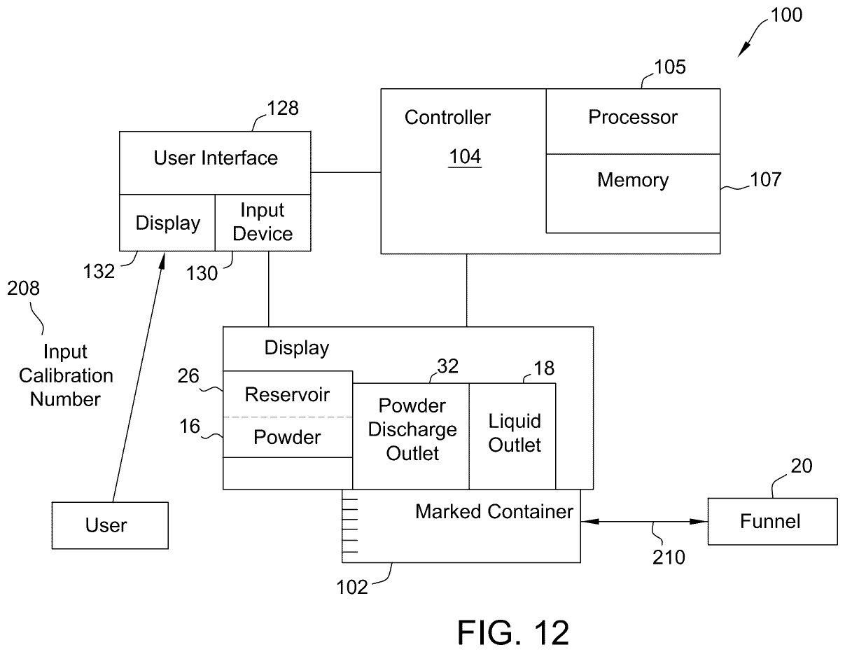

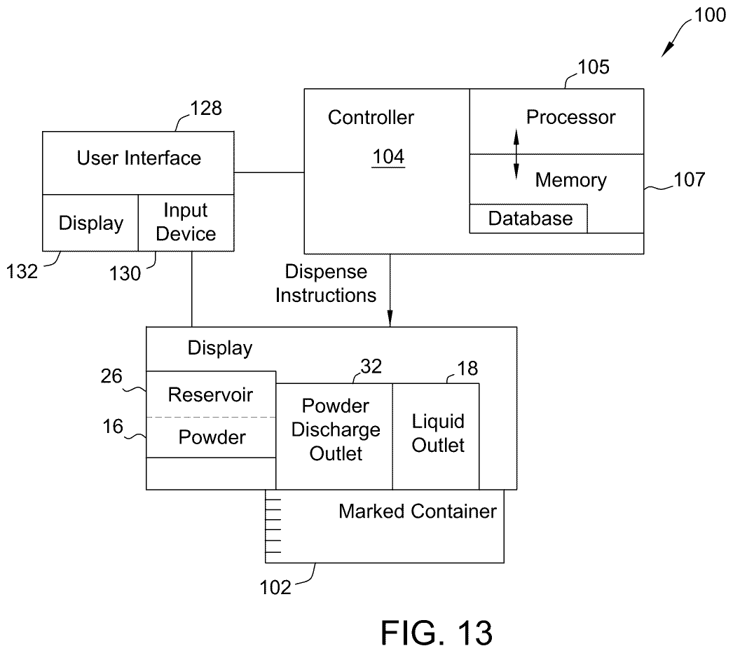

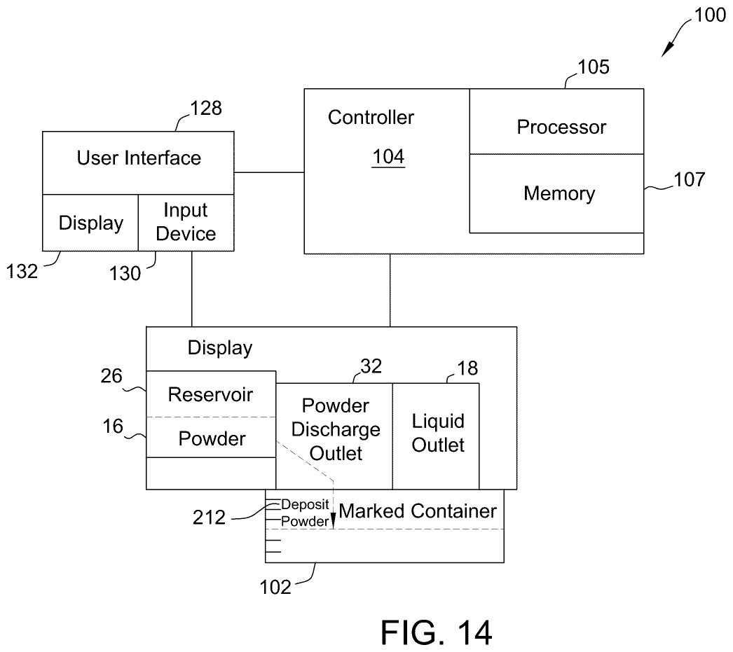

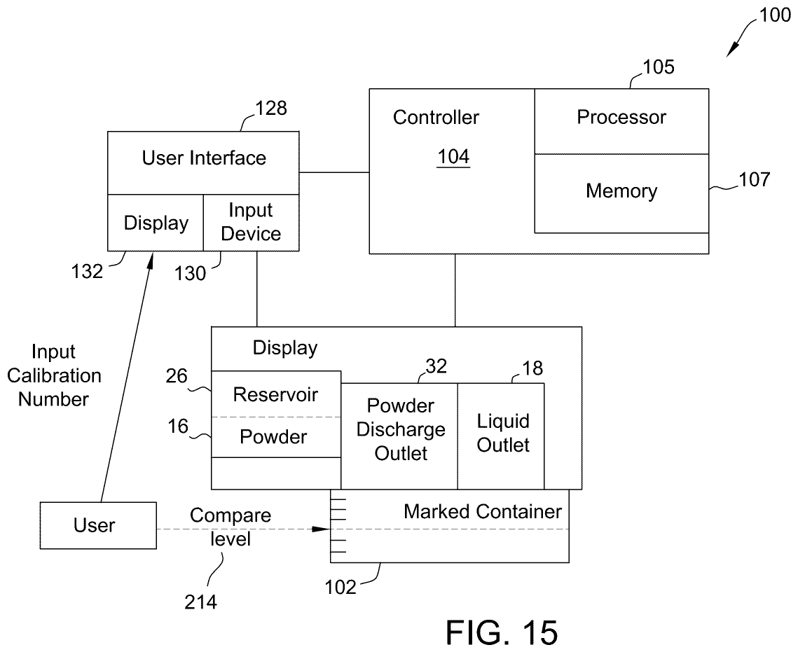

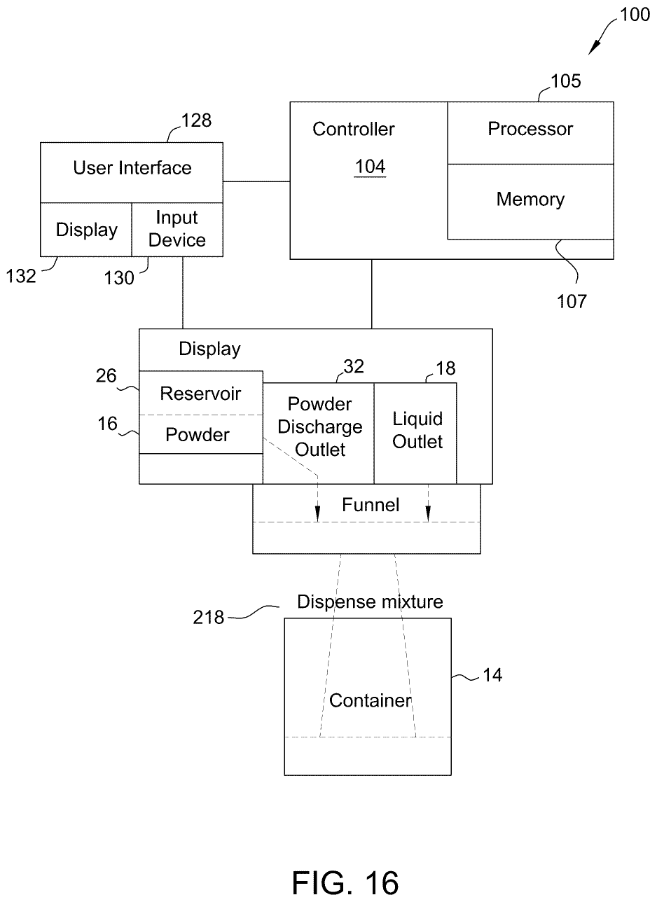

FIG. 10 is a flow diagram of one suitable embodiment of a method 200 for calibrating the dispenser 10 (illustrated in FIG. 1) using the calibration system 100 (illustrated in FIG. 3). FIGS. 11-16 are simplified schematic diagrams illustrating steps of calibrating the dispenser 10 using the calibration system 100 and the method 200. While steps of the method 200 are presented in an order that provide advantages, the steps of the method 200 may be performed, in some embodiments, in a different order and/or some steps may be omitted, and/or repeated.

Referring to FIGS. 10-16, the method 200 includes depositing 202 a manufacturer-prescribed amount of powder 16 into the marked container 102. For example, the powder 16 may be deposited using a scoop 134 or other measuring device provided by the manufacturer. The manufacturer-prescribed amount of powder may be determined based on a number of scoops or a designated volume indicated by the manufacturer, for example, on packaging of the powder and/or on a consumer accessible database. For example, the manufacturer-prescribed amount of powder for a powder-based mixture may be based on a batch of the powder-based mixture having a volume of 8 oz (236 mL) or any other suitable volume.

The method 200 includes comparing 204 a level of the powder in the marked container 102 to the level markings 118 on the marked container and determining 206 a formula calibration number based on the comparison. A user may tap or shift the marked container 102 to consolidate the powder and/or level the powder to thereby facilitate reading the level of the powder. In some embodiments, the marked container 102 includes concentric rings extending around a circumference on an inner (or outer) surface of the marked container to facilitate the user confirming that the powder is level. The user is able the level the powder within the cavity 114 of the marked container 102 and compare the level of the powder to the level markings 118. The level markings 118 correspond to a formula calibration number and the user can identify the formula calibration number that corresponds to the level of the powder by reading the indicators 126.

Also, the method 200 includes inputting 208 the formula calibration number into the dispenser 10. For example, the user inputs 208 the formula calibration number via the user interface 128. The controller 104 receives the formula calibration number and determines a formula recipe based on the formula calibration number.

The user may remove 209 the powder from the marked container 102. For example, the user may transfer the powder from the marked container 102 to the reservoir 26 of the dispenser 10 and/or discard the powder. After removal the powder, the marked container 102 is empty and ready to receive subsequent deposits of powder.

In addition, the method 200 includes positioning 210 the marked container 102 to receive powder dispensed from the discharge outlet of the dispenser 10. For example, the flanges 106 on the marked container 102 are positioned into the container interface 28 of the housing 12 to connect the marked container to the dispenser 10 below the discharge outlet of the dispenser 10. In some embodiments, the funnel 20 is removed from the dispenser 10 and the marked container 102 is positioned in place of the funnel. Powder is removed from the cavity 114 of the marked container 102, i.e., the marked container 102 is emptied, prior to positioning 210 the marked container to receive dispensed powder.

The method 200 includes dispensing 212 powder from the discharge outlet of the dispenser 10 into the marked container 102 according to the recipe determined based on the formula calibration number. For example, the powder is dispensed 212 into the marked container 102 through the open top 110 of the marked container 102.

Also, the method 200 includes comparing 214 a level of the dispensed powder in the marked container to the level markings 118 on the marked container 102, and determining 216 if the level of the dispensed powder in the marked container corresponds to the calibration number inputted into the dispenser 10. The user may compare the level of the dispensed powder and the level markings 118 while the marked container 102 is connected to the dispenser 10 or after the marked container is removed from the dispenser. The user determines the formula calibration number that corresponds to the level of the dispensed powder by reading the level markings 118.

If the level of the dispensed powder in the marked container 102 does not correspond to the calibration number inputted into the dispenser 10, the method 200 returns to comparing 204 the level of the powder in the marked container to the level markings on the marked container. Then, a second formula calibration number is determined 206 based on the comparison. The second calibration number is input 208 into the dispenser 10 and the calibration process repeated. The method 200 may be repeated until the level of the dispensed powder corresponds to the latest calibration number inputted into the dispenser 10. If the calibration cannot be completed successfully, cleaning and maintenance steps may be performed to diagnose and/or correct an operating issue with the dispenser 10.

The dispenser 10 is properly calibrated if the level of the dispensed powder in the marked container corresponds to the calibration number inputted into the dispenser 10. The controller 104 may confirm a calibration of the formula dispenser and store the calibrated settings in the memory 107. For example, a user may input a confirmation via the user interface 128. The controller 104 may then determine the calibrated settings of the formula dispenser and store calibration settings in the memory 107. The dispenser 10 is then configured to dispense powder according to the calibrated setting into, for example, a container 14.

After the dispenser 10 is calibrated, the method 200 includes dispensing 218 powder from the dispenser 10 into the container 14 based on the formula calibration number. For example, the powder may be mixed with a liquid and dispensed into the container 14, e.g., a bottle. Before the powder is dispensed, the marked container 102 may be removed from the dispenser 10 and/or the funnel 20 connected to the dispenser 10. The powder may be mixed with a liquid in the funnel 20 to form a powder-based mixture such as formula.

Technical advantages of the systems and methods include a) improving performance of dispensers by increasing accuracy of powder dispensed from the dispensers; b) reducing time required to calibrate dispensers; c) improving the production of powder-based mixtures by increasing the capabilities of dispensers to dispense powder in accordance with manufacturer prescribed recipes; d) reducing cost and skill required to measure and calibrate powder dispensers; and e) calibrating powder dispensers without the use of a weight scale.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A method for calibrating a formula dispenser using a formula calibration system, the formula calibration system including a marked container, the method comprising:
depositing a manufacturer-prescribed amount of powder into a cavity of the marked container, wherein the marked container includes level markings that correspond to formula calibration numbers of the formula dispenser;
comparing a level of the deposited powder in the cavity of the marked container and the level markings on the marked container;
determining a formula calibration number based on the comparison of the level of the deposited powder in the cavity of the marked container and the level markings on the marked container;
inputting the formula calibration number using a user interface connected to the formula dispenser, wherein a controller of the formula dispenser is configured to receive the formula calibration number and determine a formula recipe based on the formula calibration number;
positioning the marked container to receive powder dispensed from a discharge outlet of the formula dispenser;
dispensing powder according to the formula recipe from the discharge outlet of the formula dispenser into the cavity of the marked container;
comparing a level of the dispensed powder in the marked container and the level markings on the marked container; and
determining if the level of the dispensed powder in the marked container corresponds to the formula calibration number inputted into the user interface.

2. A method in accordance with claim 1, further comprising:
dispensing, based on the formula calibration number, powder from the formula dispenser into a container; and
mixing the powder and a liquid to form a powder-based mixture.

3. A method in accordance with claim 2, further comprising connecting a funnel to a container interface of the formula dispenser, wherein the funnel is arranged to receive the powder dispensed from the discharge outlet and a liquid discharged from a liquid outlet when the funnel is connected to the container interface of the formula dispenser.

4. A method in accordance with claim 3, further comprising removing the funnel from the container interface of the formula dispenser and connecting the marked container to the container interface of the formula dispenser after the funnel is removed from the formula dispenser, wherein the marked container is arranged to receive the powder dispensed from the discharge outlet when the marked container is connected to the container interface of the formula dispenser.

5. A method in accordance with claim 1, wherein the marked container includes a bottom, an open top opposite the bottom, and a sidewall, the bottom and the sidewall defining the cavity, wherein the powder is deposited into the cavity through the open top of the marked container.

6. A method in accordance with claim 1, further comprising displaying, via the user interface, a list of formula calibration numbers for a user to select.

7. A method in accordance with claim 1, further comprising inputting a second formula calibration number into the formula dispenser if the level of the dispensed powder does not correspond to the formula calibration number inputted into the formula dispenser.

8. A method in accordance with claim 1, further comprising storing, via the controller, the formula calibration number into a memory, and dispensing powder based on the stored formula calibration number.

9. A system for calibrating a formula dispenser, the system comprising:
a formula dispenser including a discharge outlet;
a marked container arranged to receive powder dispensed from the discharge outlet of the formula dispenser, the marked container comprising:
a sidewall defining a cavity sized to receive the powder dispensed from the discharge outlet of the formula dispenser; and
level markings that correspond to formula calibration numbers for the formula dispenser; and
a controller configured to:
receive an input of a formula calibration number, wherein the formula calibration number is based on a comparison of a level of the powder in the marked container and the level markings on the sidewall;
determine a formula recipe based on the formula calibration number;
cause the formula dispenser to dispense powder into the marked container according to the formula recipe determined based on the formula calibration number; and
receive a confirmation that a level of the dispensed powder in the marked container corresponds to the formula calibration number inputted into the formula dispenser based on a comparison of the level of the dispensed powder in the marked container and the level markings.

10. A system in accordance with claim 9, wherein the formula dispenser includes a container interface, and wherein the marked container is configured to releasably connect to the container interface of the formula dispenser.

11. A system in accordance with claim 10, further comprising a funnel configured to releasably connect to the container interface of the formula dispenser when the marked container is removed from the container interface, wherein the funnel is arranged to receive the powder dispensed from the discharge outlet and a liquid discharged from a liquid outlet when the funnel is connected to the container interface of the formula dispenser.

12. A system in accordance with claim 9, further comprising a user interface connected to the controller and configured for a user to input the formula calibration number.

13. A system in accordance with claim 9, wherein the controller is configured to store the formula calibration number into a memory and operate the formula dispenser to dispense powder into a container based on the stored formula calibration number.

14. A system in accordance with claim 9, wherein the controller is configured to receive a second formula calibration number if the level of the dispensed powder does not correspond to the formula calibration number inputted into the formula dispenser.

15. A system in accordance with claim 9, wherein the marked container includes a bottom, an open top opposite the bottom, and a sidewall, the bottom and the sidewall defining the cavity, wherein the powder is deposited into the cavity through the open top of the marked container.

16. A dispenser comprising:
a discharge outlet arranged to dispense powder;
a container interface arranged to receive a marked container in a position to receive powder dispensed from the discharge outlet, the marked container comprising:
a sidewall defining a cavity sized to receive the powder dispensed from the discharge outlet;
level markings that correspond to calibration numbers for the dispenser, wherein the marked container is arranged such that a user can compare a level of the powder in the marked container to the level markings; and
a controller configured to:
receive an input of a calibration number, wherein the calibration number is based on a comparison of the level of the powder in the cavity of the marked container and the level markings;
cause the dispenser to dispense powder into the cavity of the marked container based on the calibration number; and
receive a confirmation that the level of the dispensed powder in the cavity of the marked container corresponds to the calibration number inputted into the dispenser based on a comparison of a level of the dispensed powder in the marked container and the level markings.

17. A dispenser in accordance with claim 16, further comprising a funnel configured to releasably connect to the container interface of the dispenser when the marked container is removed from the container interface, wherein the funnel is arranged to receive the powder dispensed from the discharge outlet and a liquid discharged from a liquid outlet when the funnel is connected to the container interface of the dispenser.

18. A dispenser in accordance with claim 16, further comprising a user interface connected to the controller and configured for a user to input the calibration number.

19. A dispenser in accordance with claim 16, wherein the controller is configured to store the calibration number into a memory and operate the dispenser to dispense powder into a container based on the stored calibration number.

20. A dispenser in accordance with claim 16, wherein the controller is configured to receive a second calibration number if the level of the dispensed powder does not correspond to the calibration number inputted into the dispenser.
